(19) United States
(12) Patent Application Publication
(10) Pub. No.: US 2018/0257591 A1
(43) Pub. Date: Sep. 13, 2018

(54) Instructions for safe protection equipment for all vehicles and drivers

(71) Applicant: Qiusheng Gao, San Jose (CN)

(72) Inventor: Qiusheng Gao, San Jose (CN)

(21) Appl. No.: 15/456,422

(22) Filed: Mar. 10, 2017

(51) Int. Cl. B60R 19/36; B60R 19/28; B60R 19/32

(52) U.S. Cl. CPC B60R 19/36; B60R 19/32; B60R 19/28

(57) ABSTRACT

Safe protection equipment for all vehicles will significantly reduce the collision force by spring or liquid cylinder when the vehicle bumps to obstacle or two vehicles collide with each other. This equipment can be used on both front and rear of the vehicle. Combination of springs or liquid cylinder with different elasticity can reduce the collision smoothly.

This equipment will protect both vehicles and drivers without changing the current air-bag protection system. It will significantly reduce the damage for serious collision accidents.

This equipment is attached to the vehicle chassis on bottom and frame on top, which will bear the collision force reduced by the spring or liquid cylinder. It might require some design change in vehicle chassis or frame.

One option is to add a pad to pass the reduced collision force to the elastic tire when colliding vehicles are running in straight line.

### TECHNICAL FIELD

The present invention generally relates to improvements in protecting both vehicles and drivers utilizing the elasticity of spring and/or liquid cylinder from either front and/or rear over collision accidents. The spring or liquid cylinder will be compressed to reduce the colliding force when the vehicle hits an obstacle or collides with each other. The reduced colliding force will be passed to the chassis and frame of the vehicle. An additional option is to use the tire elasticity to reduce the colliding force.

There is no change for the current airbag protection system.

### BACKGROUND ART

Currently, most vehicles use airbag to protect the drivers in collision accidents. There is limitation with airbag protection. Airbag only protects driver, but not vehicle. When the vehicle hits an obstacle or collide with each other, the body and auto parts can be damaged. In case of heavy collision accident, not only the vehicles are seriously damaged, but also the drivers could be seriously injured or even killed due to the strong colliding force. Even in case the collision is not heavy, the vehicle body or auto parts are still damaged.

### SUMMARY OF THE INVENTION

An object of the present invention is to utilize the elasticity of spring or liquid cylinder or tire to reduce the colliding force and pass the reduced colliding force to the chassis or frame or tire to protect the vehicle and improve the protection over drivers. The current airbag protection system is not changed. Overall it will significantly reduce the damage for both vehicles and drivers in the collision accidents.

In accordance with the present invention, there is a tube with one or multiple springs or liquid cylinders inside. The tube is fixed to the chassis of the vehicle, one on left and one on right symmetrically. On one end of the tube, a movable cylinder is put inside the tube. This cylinder is fixed to the front bump, which is changed as a movable part from the current fixed part. To make the front bump movable, one choice is to hang the cylinder fixed to the bump to the vehicle chassis with sliding rails. On another end of the tube, another movable cylinder is also put inside the tube. This movable cylinder is fixed to a bar that connects the pair of cylinders. The bar has an optional brake pad on each end. The brake pad is near the tire. The movable cylinder is hung to the sliding rails attached to the chassis. The bar is hung to the sliding rails. The bar has another pair of cylinders that are put inside the secondary tube with spring. The secondary tube is fixed to the chassis. On top, there is a pair of tubes fixed to the bump on one end and fixed to the frame on another end.

In accordance with the present invention, when the vehicle hits an obstacle or collide with another vehicle, at bottom the cylinder fixed to the bump will push the spring or liquid cylinder, which will push another movable cylinder fixed to the bar to the tire. The brake pad will hit the tire if the vehicle is running in straight line or almost in straight line. At top, the cylinder fixed to the bump will push the spring or liquid cylinder, which will push another cylinder fixed to the frame. During this process, the spring or liquid cylinder will reduce the colliding force by compression. The elasticity of the tire also can reduce the colliding force. If the vehicle is turning left or right with big angle, the brake pad will not hit the tire, so the movable cylinder with the bar will move further to push the spring in the secondary tube. The spring in the secondary tube is compressed to reduce the colliding force. The reduced colliding force will be passed to the chassis at bottom and frame at top. If the collision is not heavy, there should be no any damage to both vehicle and driver. If the collision is heavy, it might cause the vehicle turning back and trigger the vehicle to pop up the airbag. In any case, it will significantly reduce the damage to the vehicle and driver.

In accordance with the present invention, this equipment can be installed on both front and rear of the vehicle with similar design architecture. The vehicle might need to change the chassis and frame design to attach the equipment properly.

In accordance with the present invention, either the primary tube or secondary tube can contain single or multiple springs or liquid cylinders with different elasticity, or combination of springs and liquid cylinders. The combination of springs or liquid cylinders with different elasticity will reduce the colliding force smoothly with the spring or liquid cylinder of soft elasticity being compressed first.

### BRIEF DESCRIPTION OF THE DRAWINGS

FIG. 1 provides 3D architecture view of the equipment. Unless specified, most parts are tubes or bars that do not need further different views.

FIG. 2 provides the horizontal view of the primary tube with spring or liquid cylinder from the left side of the vehicle. It is also indicated as component 14.

FIG. 3 provides the horizontal view of the secondary choice for the primary tube with spring or liquid cylinder from the left side of the vehicle. It is also indicated as component 15.

FIG. 4 provides the 3D architecture view for the portion fixed to the chassis and optional portion to pass the colliding force to the tire.

FIG. 5 provides the horizontal view of component 22 from the left side of the vehicle.

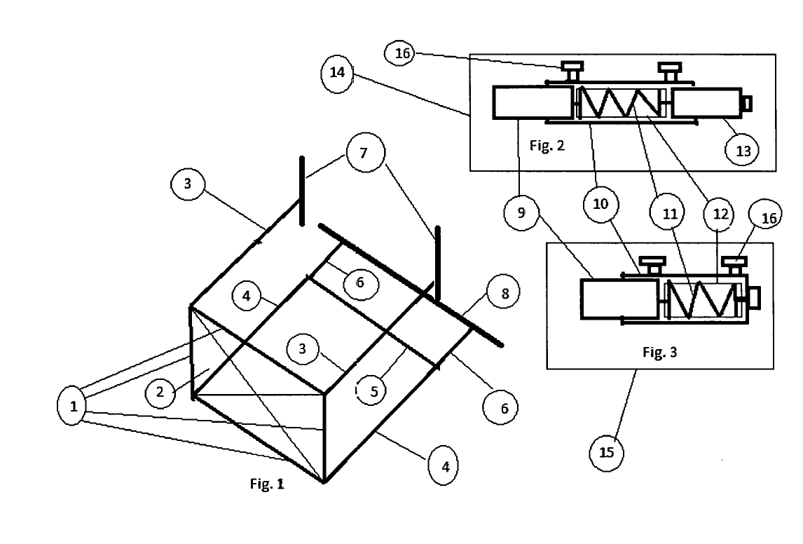

Note: Unless specified, most parts are tubes or bars. No other views are needed for design. The size needs further experiment based on the type and size of vehicles.

### DETAILED DESCRIPTION OF PREFERRED EMBODIMENTS

This equipment can be applied to all type of vehicles, e.g., cars, vans and trucks. The material can be steel or composites. The size of equipment or the elasticity of the spring (11) or liquid cylinder (12) needs further experiment based on the vehicle. A pair of tubes (10) is installed to the chassis in left and right of the vehicle symmetrically. The bump (1) can be designed in different ways such as plate or combination of tube. In case of combination of springs (11) or liquid cylinders (12), the spring (11) or liquid cylinder (12) with soft elasticity should be compressed first. The chassis and frame (7) of the vehicle need some strength enhancement. The brake pad (19) is optional. If there is brake pad (19), the primary tube (10) should be installed in left or right in the position of middle of the tire (10) when the vehicle is running in straight line. If there is no brake pad (19), the bar (5) is shorter and the primary tube (10) is installed in the position after the internal side of the tire (21) when the vehicle is running in straight line.

When the vehicle hit an obstacle or two vehicles collide with each other, on bottom, the bump (1) will push the spring (11) or liquid cylinder (12) through the movable cylinder (9) fixed to the bump (1). The spring (11) or the liquid cylinder (12) will push the second movable cylinder (13) fixed to the bar (5). If the vehicle is running in straight line or almost straight line, the brake pad (20) will hit the tire (21). During this process, the spring (11) or liquid cylinder (12) inside the tube (10) will be compressed to reduce the colliding force. The elasticity of the tire (21) will also reduce the colliding force. If the vehicle is turning left or right with big angle, the brake pad (20) will not hit the tire (21) and the cylinder (13) will move forward to push the spring (25) in secondary tube (24). The spring (25) in secondary tube will be compressed to reduce the colliding force. The secondary tube (24) will pass the reduced colliding force to the chassis. On top, the bump (1) will push the spring (11) or liquid cylinder (12) through the movable cylinder (9) fixed to the bump (1). The spring (11) or the liquid cylinder (12) will push the tube (10) fixed to the frame. During this process, the spring (11) or the liquid cylinder (12) is compressed to reduce the colliding force. The reduced colliding force is passed to the frame (7) by the tube (10).

If the colliding is very heavy, it might cause the vehicle turning back and trigger the vehicle to pop up the airbag. In any case, the damage to the vehicle and the driver will be significantly reduced in case of collision accidents.

1. A primary tube in FIG. 2 with spring or liquid cylinder comprising:
a tube (10)
a part (16) fixing the tube to the chassis
single or multiple springs (11) or liquid cylinders (12) or combination of springs (11) and liquid cylinders (12)
2 movable cylinders inside each end of the tube being able to move forth and back, one (9) fixed to the bump (1) and another (13) fixed to the bar (5), both are hung to sliding rails characterized in that the first movable cylinder (9) fixed to the bump push the spring (11) or liquid cylinder (12) that push the movable cylinder (13) fixed to the bar (5) moving towards the tire (21) or the secondary tube (24) thereof the spring (11) or liquid cylinder (12) in the primary tube (10) will be compressed to reduce the colliding force.

2. The primary tube as claimed in claim 1 characterized in that the combination of springs (11) or liquid cylinders (12) with different elasticity will reduce the colliding force smoothly with the spring or liquid cylinder of soft elasticity being compressed first.

3. The primary tube as claimed in claim 1 characterized in that the tire elasticity will reduce the colliding force if the brake pad (20) hit the tire (21) when the vehicle is running in straight line or almost straight line.

4. The primary tube as claimed in claim 1 characterized in that the reduced colliding force will be passed to the chassis through the secondary tube if the vehicle is turning left or right with big angle and the brake pad does not hit the tire.

5. The primary tube as claimed in claim 1 characterized in that the tube can be applied to any type of vehicle such as car, van, truck and train

6. The primary tube as claimed in claim 1 characterized in that the tube can be applied to front and/or rear of the vehicle.

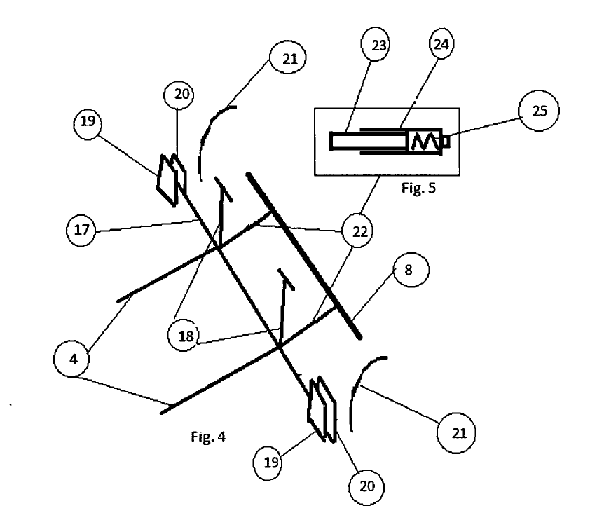

7. The primary tube in second structure in FIG. 3 with spring or liquid cylinder comprising:
a tube (10)
a part (16) fixing the tube to the chassis
single or multiple springs (11) or liquid cylinders (12) or combination of springs (11) and liquid cylinders (12)
one movable cylinder (9) being hung to sliding rails fixed to the chassis or frame characterized in that the movable cylinder (9) will push the spring (11) or liquid cylinder (12) that push the tube (10) fixed to the chassis or frame thereof the spring (11) or liquid cylinder being compressed to reduce the colliding force.

8. The primary tube in second structure as claimed in claim 7 characterized in that the tube passes the reduced colliding force to the chassis or frame of the vehicle.

9. The primary tube in second structure as claimed in claim 7 characterized in that the tube can be applied to any type of vehicle such as car, van, truck and train

10. The primary tube in second structure as claimed in claim 7 characterized in that the tube can be applied to front and/or rear of the vehicle.

11. The secondary tube in FIG. 5 with spring or liquid cylinder comprising:
a tube (24)
a movable cylinder (23) being hung to sliding rails
single or multiple springs (25)
characterized in that the movable cylinder (23) inside the secondary tube (24) will push the spring (25) being compressed to reduce the colliding force.

12. The secondary tube as claimed in claim 11 characterized in that the secondary tube (24) passes the reduced colliding force to the chassis of the vehicle.

13. The secondary tube as claimed in claim 11 characterized in that the tube can be applied to any type of vehicle such as car, van, truck and train

14. The secondary tube as claimed in claim 11 characterized in that the tube can be applied to front and/or rear of the vehicle.
